(19) United States
(12) Patent Application Publication
(10) Pub. No.: US 2005/0028639 A1
(43) Pub. Date: Feb. 10, 2005

(54) Luminous pedals for bicycles

(76) Inventor: Jen-Show Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/632,903

(22) Filed: Aug. 4, 2003

(51) Int. Cl. G05G 1/14

(52) U.S. Cl. 74/594.4

(57) ABSTRACT

A bicycle pedal includes a body with an axle rotatably received therein and a rotator is connected on the axle and enclosed by a stator. The body includes two rounded corners in the distal end thereof and each rounded corner has a recessed area and a luminous element is received in the recessed area. The recessed area extends to a side of the body so that the luminous element can be seen from distance from a large range of angles. Two reflectors are connected to two sides of the body.

### FIELD OF THE INVENTION

The present invention relates to a luminous pedal for bicycles and includes luminous elements located at corners of the front end and rear end of the pedal so that the luminous elements are not hidden by the cyclist's foot.

### BACKGROUND OF THE INVENTION

A conventional luminous pedal for bicycles is disclosed in U.S. Pat. No. 6,550,945 and includes a plurality of luminous elements connected to luminous plates on two sides of the pedal so as to allow the drivers to see the cyclists during dark areas. Nevertheless, the luminous plates are located on two sides of the pedal and when the cyclist's foot steps on the pedal, the luminous plates could be hidden by the cyclist's foot. This reduces the changes that the drivers see the luminous elements and increases risk of being accidentally hit by the cars. Furthermore, the positions where the luminous plates are located make them to be easily broken when the bicycle falls a side.

The present invention intends to provide a bicycle pedal wherein the luminous elements are located at corners of distal ends of the pedals and reflectors are attached to two sides of the pedal so that they are not hidden by the cyclist's foot and the drivers easily see the pedals from distance.

### SUMMARY OF THE INVENTION

In accordance with one aspect of the present invention, there is provided a bicycle pedal which comprises a body including a central frame which has a passage defined therein so as to receive an axle therein. A distal end of the body has two rounded corners and each rounded corner extends to a side of the body and has a recessed area for receiving at least one first luminous element therein.

The axle has a rotor mounted thereto and a stator engaged with the body of the pedal is mounted to the rotor such that the rotor is rotated relative to the stator. The stator has a coil received therein and is electrically connected to the at least one first luminous element in the rounded corners of the body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pedal of the present invention;

FIG. 2 shows a cross sectional view of the pedal of the present invention;

FIG. 3 is a perspective view of the pedal of the present invention, and

FIG. 4 is an exploded view to show the stator of the pedal of the present invention.

### DETAILED DESCRIPTION OF THE PREFERRED EMBODIMENT

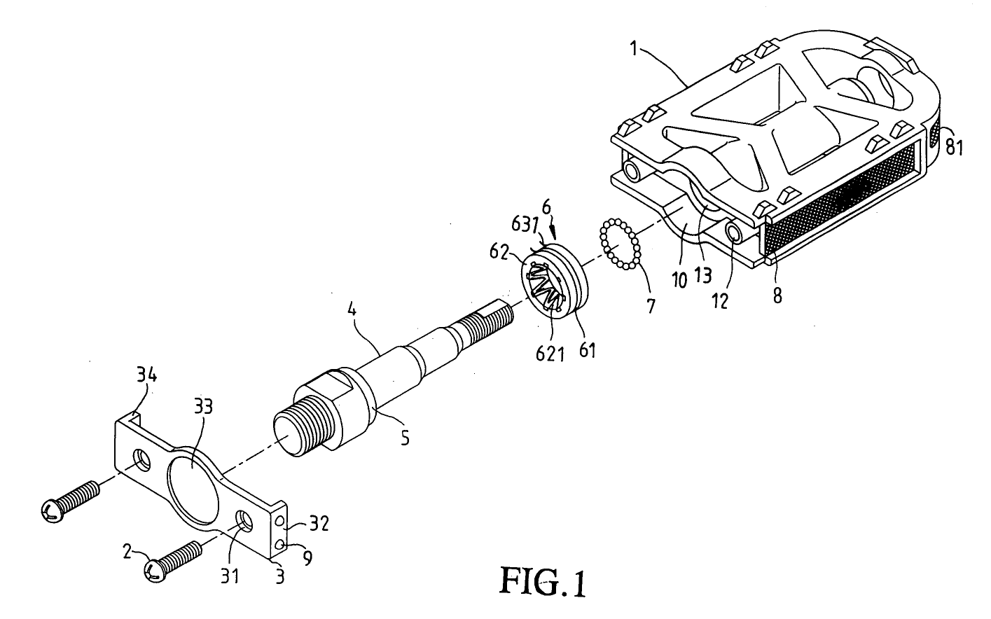

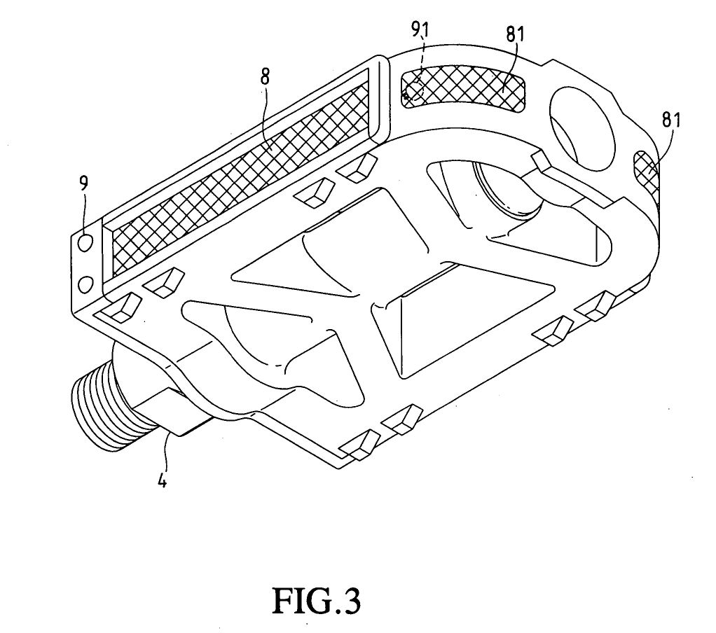

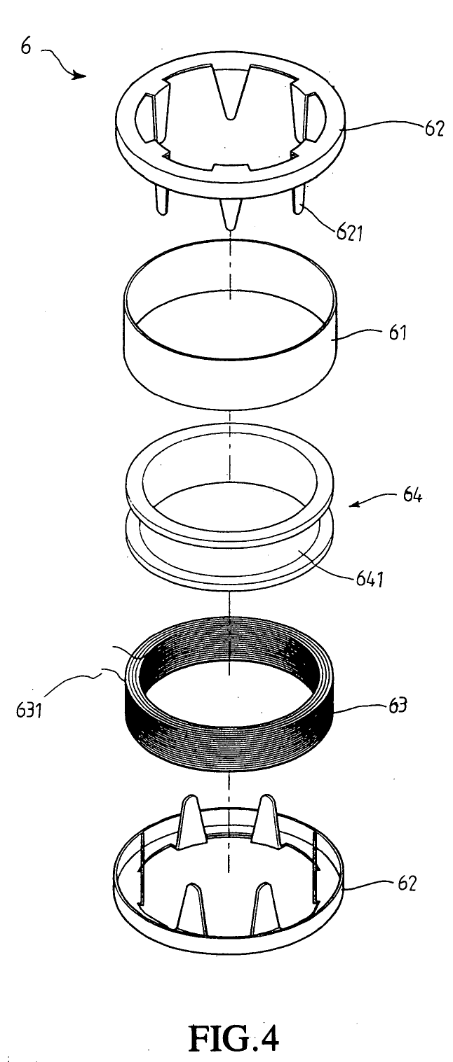

Referring to FIGS. 1 to 4, the bicycle pedal of the present invention comprises a body 1 including a central frame which has a passage 13 defined therein so as to receive an axle 4 therein and the body 1 has a distal end which having two rounded corners. Each rounded comer extends to a side of the body 1 and has a recessed area defined therein. At least one first luminous element 91 is received in the recessed area in each of the rounded corners and a netted cover piece 81 is engaged with each recessed area so that the at least one first luminous element 91 can be protected by the netted cover piece 81. The netted cover piece 81 can be a reflector member so as to increase the visibility of the pedal in the dark. Two reflectors 8 are connected to two sides of the body 1.

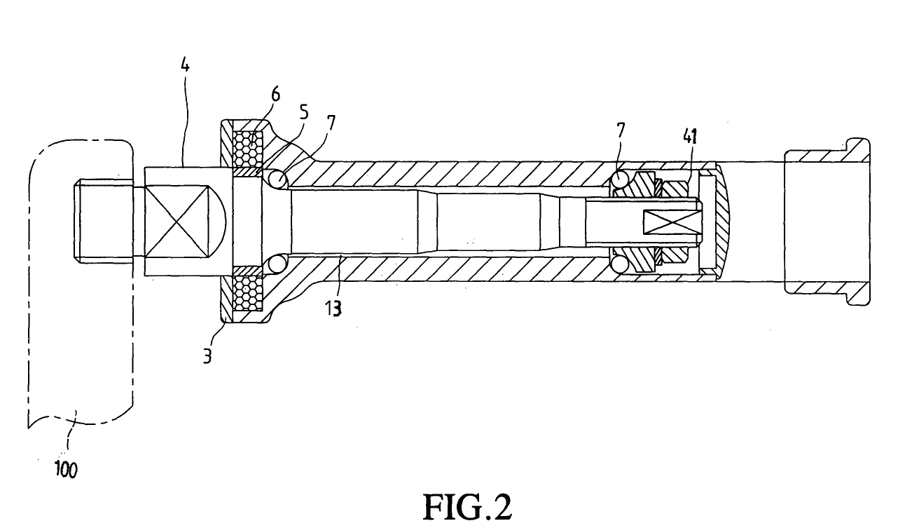

The axle 20 is inserted in the passage 13 in the central frame of the body 1 and at least one bearing 7 is mounted to the axle 20 so that the body 1 can be rotated about the axle 20. A first end of the axle 20 extends from the central frame and is fixed by a nut 41, and a second end of the axle 20 extends through a hole 33 in an end plate 3 and is connected to a crank 100 as shown in FIG. 2. The body 1 has two tubes 12 at the end that the end plate 3 is connected and two bolts 2 extend through two holes 31 in the end plate 3 and threadedly connected to the tubes 12. The end plate 3 has two sidewalls 34 perpendicularly extending from two ends thereof and each sidewall 34 has holes 32 defined therethrough. Each hole 32 has a second luminous element 9 received therein. A rotor 5 is connected to the axle 20.

A stator 6 is received in a space 10 defined in the end close to the crank of the body 1 the passage 13 and the axle 20 extends through the stator 6 which encloses the rotor 5 such that the rotor 5 is rotated relative to the stator 6. The stator 6 includes a ring 64 having a groove 641 defined in an outer periphery thereof and a coil 63 is received in the groove 641. An isolation collar 61 is mounted to the ring 64 and covers the groove 641 so that the coil. 63 is isolated from the body 1 of the pedal. Two leading ends 631 of the coil 63 are electrically connected to the at least one first luminous element 91 in the rounded corners of the body 1 and the second luminous elements 9 in the end plate 3. Two conductive frames 62 sandwiches the ring 64 therebetween and each conductive frame 62 includes a plurality of extensions 621. The rotor 5 includes magnetic poles which are arranged N-pole by S-pole alternately, and the number of the poles is the same as the number of the extensions 621.

It is to be noted that, the at least one first luminous element 91 and the second luminous elements 9 will not be hidden by the cyclist's foot so that the shortcoming of the conventional pedal can be effectively improved.

While we have shown and described the embodiment in accordance with the present invention, it should be clear to those skilled in the art that further embodiments may be made without departing from the scope of the present invention.

1. A bicycle pedal comprising:
a body including a central frame which has a passage defined therein and a distal end of the body having two rounded corners, each rounded corner extending to a side of the body and having a recessed area defined therein, at least one first luminous element received in the recessed area in each of the rounded corners;
an axle inserted in the passage in the central frame of the body and at least one bearing mounted to the axle, a first end of the axle extending from the central frame and fixed by a nut and a second end of the axle extending through an end plate and adapted to be connected to a crank, a rotor connected to the axle, and
a stator engaged with the body and the axle extending through the stator and mounted to the rotor such that the rotor is rotated relative to the stator, the stator having a coil received therein and being electrically connected to the at least one first luminous element in the rounded corners of the body.

2. The pedal as claimed in claim 1, wherein each recessed area in each of the rounded corners of the body has a netted cover piece engaged therewith.

3. The pedal as claimed in claim 2, wherein the netted cover piece is a reflector member.

4. The pedal as claimed in claim 1 further comprising two reflectors connected to two sides of the body.

5. The pedal as claimed in claim 1, wherein the end plate has two sidewalls perpendicularly extending from the end plate and each sidewall has holes defined therethrough, each hole has a second luminous element received therein.

6. The pedal as claimed in claim 1, wherein the stator includes a ring having a groove defined in an outer periphery thereof and the coil is received in the groove, an isolation collar mounted to the ring and covering the groove, two conductive frames sandwiching the ring therebetween.
